(19) United States
(12) Patent Application Publication
(10) Pub. No.: US 2013/0315385 A1
(43) Pub. Date: Nov. 28, 2013

(54) SPEECH RECOGNITION BASED QUERY METHOD AND APPARATUS

(71) Applicant: Huawei Technologies Co., Ltd., Shenzhen (CN)

(72) Inventors: Ye Zhao, Shenzhen (CN); Hongkai Zhou, Shenzhen (CN)

(73) Assignee: Huawei Technologies Co., Ltd., Shenzhen (CN)

(21) Appl. No.: 13/899,110

(22) Filed: May 21, 2013

Related U.S. Application Data
(63) Continuation of application No. PCT/CN2012/082965, filed on Oct. 15, 2012.

(30) Foreign Application Priority Data
May 23, 2012 (CN) 201210161738.7

(51) Int. Cl. H04M 3/51

(52) U.S. Cl. CPC H04M 3/5166
USPC 379/88.01

(57) ABSTRACT

Embodiments of the present invention provide a speech recognition based query method and apparatus, relating to the communication field and capable of increasing the accuracy of speech recognition and improving the working efficiency. The method includes: when determining that a received customer speech is a non-standard speech, forwarding the speech of the customer to an agent to prompt the agent to make a standard speech; extracting a keyword of the received standard speech of the agent; and querying according to the keyword of the standard speech of the agent, and obtaining a query result, so that the agent provides a service for the customer according to the query result. The embodiments of the present invention are applied in a customer service system.

### CROSS-REFERENCE TO RELATED APPLICATIONS

This application is a continuation of International Application No. PCT/CN2012/082965, filed on Oct. 15, 2012, which claims priority to Chinese Patent Application No. 201210161738.7, filed on May 23, 2012, both of which are hereby incorporated by reference in their entireties.

### TECHNICAL FIELD

The present invention relates to the communication field, and in particular, to a speech recognition based query method and apparatus.

### BACKGROUND

As competition becomes increasingly fierce in service sectors, each service sector attaches more importance to customer satisfaction and feedback, and the building of a customer service system is increasingly improved. Through the customer service system, customers can implement multiple services such as querying call costs, knowing service details, feeding back opinions, making complaints, subscribing to services, or unsubscribing from services.

The customers communicate, by dialing an access code, with an agent through a CC (Call Center, call center) in the customer service system, where the CC system is generally integrated in a CRM (Customer Relationship Management, customer relationship management) system. The agent provides remote services for the customers through the CC system. Common remote services include a complete agent service and a speech recognition service. The complete agent service means that the agent switches multiple service modules in the CRM software to find pages related to problems queried by the customers and provides services for the customers. The speech recognition service means that problems are located through the speech recognition of the customers and related pages are found automatically, and then the agent provides services for the customers.

In the process of implementing access of the foregoing customer service system, the inventor discovers that the prior art has at least the following problems: When the complete agent service is applied, the agent needs to switch multiple service modules in order to find related pages, which causes low finding efficiency; and when the speech service is applied, a customer speech may not be recognized accurately because the speech of the customer is not standard or a term is not standard, and the speech recognition service needs to be switched to the complete agent service, which also causes low efficiency.

### SUMMARY

Embodiments of the present invention provide a speech recognition based query method and apparatus, which can increase the accuracy of speech recognition and improve the working efficiency.

To achieve the foregoing objective, the embodiments of the present invention adopt the following technical solutions:
a speech recognition based query method includes:

judging whether a received speech of a customer is a standard speech;

if the speech of the customer is a non-standard speech, forwarding the speech of the customer to an agent to prompt the agent to make a standard speech;

receiving the standard speech of the agent and extracting a keyword of the standard speech of the agent; and

querying according to the keyword of the standard speech of the agent, and obtaining a query result, so that the agent provides a service for the customer according to the query result.

A speech recognition based query apparatus includes:

a judging unit, configured to judge whether a received speech of a customer is a standard speech;

a sending unit, configured to: if the judging unit determines that the speech of the customer is a non-standard speech, forward the speech of the customer to an agent to prompt the agent to make a standard speech;

a receiving unit, configured to receive the standard speech of the agent;

a keyword extracting unit, configured to extract a keyword of the standard speech of the agent which is received by the receiving unit; and

a querying unit, configured to query according to the keyword of the standard speech of the agent which is extracted by the keyword extracting unit, and obtain a query result, so that the agent provides a service for the customer according to the query result.

By using a speech recognition based query method and apparatus provided by embodiments of the present invention, when a received customer speech is determined to be a non-standard speech, the speech of the customer is forwarded to an agent to prompt the agent to make a standard speech; a keyword of the received standard speech of the agent is extracted; and query is performed according to the keyword of the standard speech of the agent and a query result is obtained, so that the agent provides a service for the customer according to the query result. In this way, speech recognition may also be performed accurately in a situation where the speech of the customer is not standard or a term is not standard, which increases the accuracy of the speech recognition, speeds up the query, and improves the working efficiency.

### BRIEF DESCRIPTION OF THE DRAWINGS

To describe the technical solutions in the embodiments of the present invention more clearly, the following briefly describes the accompanying drawings required for describing the embodiments or the prior art. Apparently, the accompanying drawings in the following descriptions show merely some embodiments of the present invention, and persons of ordinary skill in the art may still derive other drawings from the accompanying drawings without creative efforts.

FIG. 1 is a schematic flowchart of a speech recognition based query method according to an embodiment of the present invention;

FIG. 2 is another schematic flowchart of a speech recognition based query method according to an embodiment of the present invention; and

FIG. 3 is a schematic structural diagram of a speech recognition based query apparatus according to an embodiment of the present invention.

### DETAILED DESCRIPTION

The following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

### Embodiment 1

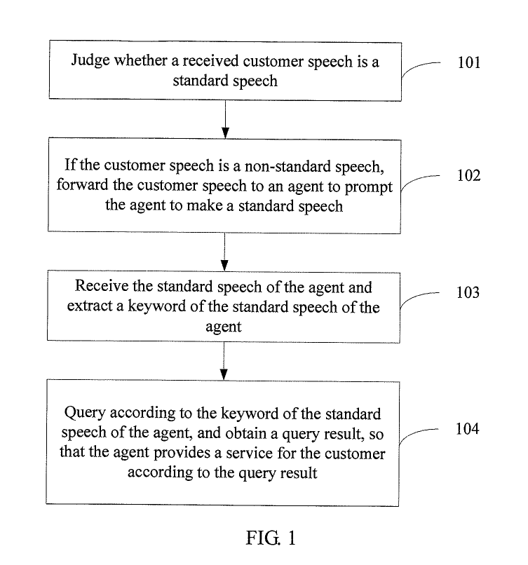

The embodiment of the present invention provides a speech recognition based query method. As shown in FIG. 1, the method includes the following steps:

101. Judge whether a received speech of a customer is a standard speech.

A customer begins to access a customer service system by dialing an access code, and sends a speech of a customer to the customer service system through a customer terminal, and the speech of the customer includes a service desired by the customer. After receiving the speech of the customer, the customer service system judges whether the speech of the customer is a standard speech by using a speech recognition technology. It should be noted that the standard speech herein includes not only standard pronunciation, that is, the language spoken by the customer is standard Mandarin, but also standard terms, that is, the speech of the customer includes service wording.

If the customer service system recognizes that the speech of the customer includes standard service wording, the customer service system determines that the received customer speech is a standard speech; otherwise, the customer service system determines that the received customer speech is a non-standard speech.

102. If the speech of the customer is a non-standard speech, forward the speech of the customer to an agent to prompt the agent to make a standard speech.

If the customer service system determines that the speech of the customer is a non-standard speech, the customer service system forwards the speech of the customer to an agent; and after hearing the speech of the customer, the agent makes a standard speech according to the non-standard speech.

103. Receive the standard speech of the agent and extract a keyword of the standard speech of the agent.

The customer service system may receive the standard speech of the agent, and then extract a keyword of the standard speech of the agent by using a speech recognition technology.

104. Query according to the keyword of the standard speech of the agent, and obtain a query result, so that the agent provides a service for the customer according to the query result.

After extracting the keyword of the standard speech of the agent, the customer service system queries for all services automatically according to the keyword, and obtains a query result related to the keyword. The query result includes all service links related to the keyword or a service page related to the keyword.

If the query result is all service links related to the keyword, the agent may select a service link needed by the customer from the service links, and clicks the service link to enter the service page directly to provide a service for the customer; and if the query result is a service page related to the keyword, the agent may provide a service for the customer directly according to the service page. In this way, compared with the complete agent service in the prior art, the query is speeded up and the working efficiency of the agent is further improved; and compared with the speech recognition service, by combining the speech recognition of the customer and speech recognition of the agent, the accuracy of speech recognition is increased and the query is also speeded up.

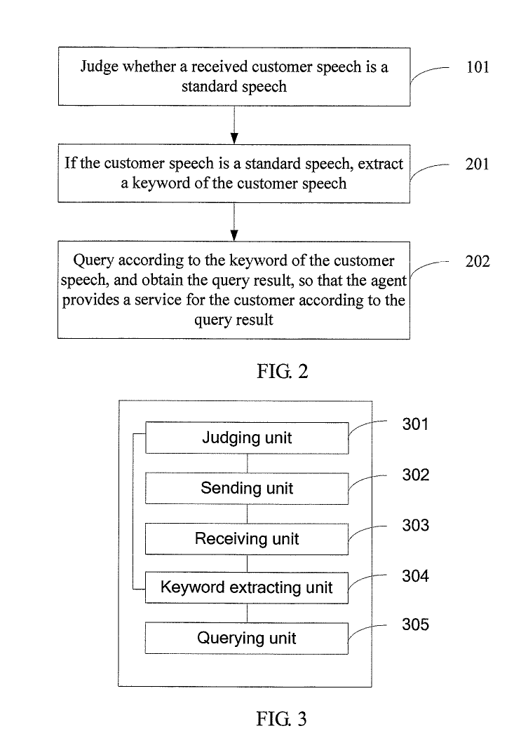

The method described in the foregoing step 101 to step 104 is a query method performed when the speech of the customer is not standard. Furthermore, as shown in FIG. 2, the method further includes the following steps:

101. Judge whether a received speech of a customer is a standard speech.

If the customer service system recognizes that the speech of the customer includes standard service wording, the customer service system determines that the received customer speech is a standard speech; otherwise, the customer service system determines that the received customer speech is a non-standard speech.

201. If the speech of the customer is a standard speech, extract a keyword of the speech of the customer.

If the customer service system recognizes that standard service wording exist in the speech of the customer, the customer service system determines that the speech of the customer is a standard speech, and then the customer service system extracts a keyword of the speech of the customer directly by using a speech recognition technology.

202. Query according to the keyword of the speech of the customer, and obtain a query result, so that the agent provides a service for the customer according to the query result.

After extracting the keyword of the customer speech, the customer service system queries for all services automatically according to the keyword, and obtains a query result related to the keyword. The query result includes all service links related to the keyword or a service page related to the keyword.

If the query result is all service links related to the keyword, the agent may select a service link needed by the customer from the service links, and clicks the service link to enter the service page directly to provide a service for the customer; and if the query result is a service page related to the keyword, the agent may provide a service for the customer directly according to the service page. In this way, compared with the complete agent service in the prior art, the query is speeded up, and the working efficiency of the agent is further improved.

The method may be applied in the following instance: A GoTone subscriber Mr. Li dials 10086 to ask for help from Mr. Zhang, a customer service agent of China Mobile, which involves the following two cases:

A. A speech of Mr. Li is a standard speech. After the call is connected successfully, Mr. Li says “I want to query for account information”; at this time, the customer service system may recognize the keyword “account”, and may obtain, through automatic query, a menu formed by all service links related to the “account”; and then Mr. Zhang may ask Mr. Li what specific service is desired and select a corresponding service link on the menu to enter the service page directly. In this way, the system performs automatic query, thereby speeding up the query.

B. The speech of Mr. Li is a non-standard speech. The non-standard speech herein may include two cases: One case is that Mr. Li speaks a dialect and his pronunciation is not standard; and the other case is that Mr. Li speaks Mandarin but the system cannot recognize specialized service terms. After the call is connected successfully, Mr. Li says “I want to check my account” in dialect or says “I want to check my account “in Mandarin, the customer service system cannot recognize standard service wording from the two types of speech, and then determines that the speech of Mr. Li is a non-standard speech. At this time, the customer service system sends “I want to check my account” to Mr. Zhang, and Mr. Zhang makes a standard speech “Ok, I will help you query for your account profile”; and at this time, the system may recognize the keyword “account” according to the speech of Mr. Zhang, and obtain, through automatic query, a menu formed by all service links related to the “account”. Then, Mr. Zhang may ask Mr. Li what specific service is desired and select a corresponding service link on the menu to enter the service page directly. In this way, the system performs automatic query, thereby speeding up the query. In addition, speech recognition query may also be performed by using speech recognition when the speech of Mr. Li is not standard.

An embodiment of the present invention also provides a speech recognition based query apparatus. As shown in FIG. 3, the apparatus includes a judging unit 301, a sending unit 302, a receiving unit 303, a keyword extracting unit 304, and a querying unit 305.

The judging unit 301 is configured to judge whether a received speech of a customer is a standard speech.

A customer begins to access a customer service system by dialing an access code, and sends a speech of a customer to the customer service system through a customer terminal, and the speech of the customer includes a service desired by the customer. After receiving the speech of the customer, the customer service system judges whether the speech of the customer is a standard speech by using a speech recognition technology. It should be noted that the standard speech herein includes not only standard pronunciation, that is, the language spoken by the customer is standard Mandarin, but also standard terms, that is, the speech of the customer includes service wording.

If the judging unit 301 recognizes that the speech of the customer includes standard service wording, the judging unit 301 determines that the received customer speech is a standard speech; otherwise, the judging unit 301 determines that the received customer speech is a non-standard speech.

The sending unit 302 is configured to: if the judging unit 301 determines that the speech of the customer is a non-standard speech, forward the speech of the customer to an agent to prompt the agent to make a standard speech.

If the judging unit 301 determines that the speech of the customer is a non-standard speech, the sending unit 301 forwards the speech of the customer to an agent; and after hearing the speech of the customer, the agent makes a standard speech according to the non-standard speech.

The receiving unit 303 is configured to receive the standard speech of the agent.

The keyword extracting unit 304 is configured to extract a keyword of the standard speech of the agent which is received by the receiving unit.

The receiving unit 303 may receive the standard speech of the agent, and then the keyword extracting unit 304 extracts the keyword of the standard speech of the agent by using a speech recognition technology.

The querying unit 305 is configured to query according to the keyword of the standard speech of the agent which is extracted by the keyword extracting unit, and obtain a query result, so that the agent provides a service for the customer according to the query result.

After the keyword extracting unit 304 extracts the keyword of the standard speech of the agent, the querying unit 305 queries for all services automatically according to the keyword, and obtains a query result related to the keyword. The query result includes all service links related to the keyword or a service page related to the keyword.

If the query result is all service links related to the keyword, the agent may select a service link needed by the customer from the service links, and clicks the service link to enter the service page directly to provide a service for the customer; and if the query result is a service page related to the keyword, the agent may provide a service for the customer directly according to the service page. In this way, compared with the complete agent service in the prior art, the query is speeded up and the working efficiency of the agent is further improved; and compared with the speech recognition service, by combining the speech recognition of the customer and speech recognition of the agent, the accuracy of speech recognition is increased and the query is further speeded up.

Furthermore, the keyword extracting unit 304 is further configured to: when the speech of the customer is a standard speech, extract a keyword of the speech of the customer.

If the judging unit 301 determines that the speech of the customer is a standard speech, the customer service system extracts a keyword of the speech of the customer directly by using a speech recognition technology.

The querying unit 305 is further configured to query according to the keyword of the speech of the customer, and obtain the query result, so that the agent provides a service for the customer according to the query result.

After the keyword extracting unit 304 extracts the keyword of the customer speech, the querying unit 305 queries for all services automatically according to the keyword, and obtains a query result related to the keyword. The query result includes all service links related to the keyword or a service page related to the keyword.

If the query result is all service links related to the keyword, the agent may select a service link needed by the customer from the service links, and clicks the service link to enter the service page directly to provide a service for the customer; and if the query result is a service page related to the keyword, the agent may provide a service for the customer directly according to the service page. In this way, compared with the complete agent service in the prior art, the query is speeded up, and the working efficiency of the agent is further improved.

By using a speech recognition based query method and apparatus provided by embodiments of the present invention, when a received customer speech is determined to be a non-standard speech, the speech of the customer is forwarded to an agent to prompt the agent to make a standard speech; a keyword of the received standard speech of the agent is extracted; and query is performed according to the keyword of the standard speech of the agent and a query result is obtained, so that the agent provides a service for the customer according to the query result. In this way, speech recognition may also be performed accurately in a situation where the speech of the customer is standard or a term is standard, which increases the accuracy of the speech recognition, speeds up the query, and improves the working efficiency.

Persons of ordinary skill in the art may understand that all or part of the steps of the methods in the embodiments may be implemented by a program instructing relevant hardware. The program may be stored in a computer readable storage medium. When the program is run, the foregoing steps of the methods in the embodiments are performed. The storage medium may be any medium capable of storing program codes, such as a ROM, a RAM, a magnetic disk, or an optical disk.

The foregoing descriptions are merely specific embodiments of the present invention, but are not intended to limit the protection scope of the present invention. Any variation or replacement readily figured out by persons skilled in the art within the technical scope disclosed in the present invention shall all fall within the protection scope of the present invention. Therefore, the protection scope of the present invention shall be subject to the protection scope of the appended claims.

What is claimed is:

1. A query method based on speech recognition, the method comprising:
judging whether a received speech of a customer is a standard speech;
if the speech of the customer is a non-standard speech, forwarding the speech of the customer to an agent to prompt the agent to make a standard speech;
receiving the standard speech of the agent and extracting a keyword of the standard speech of the agent; and
querying according to the keyword of the standard speech of the agent, and obtaining a query result, so that the agent provides a service for the customer according to the query result.

2. The method according to claim 1, comprising:
if the speech of the customer is a standard speech, extracting a keyword of the speech of the customer; and
querying according to the keyword of the speech of the customer, and obtaining the query result, so that the agent provides a service for the customer according to the query result.

3. The method according to claim 1, wherein the query result comprises all service links related to the keyword or a service page related to the keyword.

4. A speech recognition based query apparatus, comprising:
a judging unit, configured to judge whether a received speech of a customer is a standard speech;
a sending unit, configured to: if the judging unit determines that the speech of the customer is a non-standard speech, forward the speech of the customer to an agent to prompt the agent to make a standard speech;
a receiving unit, configured to receive the standard speech of the agent;
a keyword extracting unit, configured to extract a keyword of the standard speech of the agent which is received by the receiving unit; and
a querying unit, configured to query according to the keyword of the standard speech of the agent which is extracted by the keyword extracting unit, and obtain a query result, so that the agent provides a service for the customer according to the query result.

5. The apparatus according to claim 4, wherein:
the keyword extracting unit is further configured to: when the speech of the customer is a standard speech, extract a keyword of the speech of the customer; and
the querying unit is further configured to query according to the keyword of the speech of the customer, and obtain the query result, so that the agent provides a service for the customer according to the query result.

6. The apparatus according to claim 4, wherein the query result comprises all service links related to the keyword or a service page related to the keyword.
